(19) United States
(12) Patent Application Publication
(10) Pub. No.: US 2009/0270913 A1
(43) Pub. Date: Oct. 29, 2009

(54) Sacrifical teething attachment for books

(76) Inventor: Allison Abrahamson, New York, NY (US)

Correspondence Address: Mark A. Litman & Associates, P.A., 3209 West 76th St., York Buinsess Center, Suite 205, Edina, MN, 55435, US

(21) Appl. No.: 12/150,531

(22) Filed: Apr. 29, 2008

(51) Int. Cl. A61J 17/02

(52) U.S. Cl. 606/235

(57) ABSTRACT

A replaceable article can be secured to and removed from the binding or backing of a children's book. The device can be chewed on without damage to the book or injury to the child. The device can slide onto the binding area and extend away from the book to provide an attracting appearance. The article may be replaced or partially replaced and the size of the device avoids any significant issue of potential choking for the child.

### BACKGROUND OF THE INVENTION

1. Field of the Invention

The present invention relates to the field of books, particularly children's books and to the protection of children's books from chewing during the teething stage for infants or orally active children.

2. Background of the Art

During the first 18 months the average child begins teething, develops sensory discrimination, and begins to walk and talk. Children usually begin teething with the emergence of the two bottom front teeth, followed about four to eight weeks later by the four upper teeth, and then about one month later by the two lower incisors. The first molars come in next, followed by the canine or eye teeth. Parents and caregivers are encouraged to soothe the child at this stage by gently rubbing or massaging the child's gums with a finger. Teething rings are helpful as well, and are preferably made from a firm material such as rubber. During this stage, children chew on nearly anything that will fit into their mouth to relieve the irritation in their gums. Some children develop an intense oral satisfaction during this stage, and they continue to chew objects further into their life.

The U.S. Department of Education and many other authorities encourage parents to read to children, beginning at a very early age. With the help of their parents and other caregivers, children can begin a lifelong relationship with the printed word, so they grow into adults who read easily and frequently whether for business, knowledge, or pleasure.

Children develop a fondness for the pleasure associated with the reading experience, including the books themselves. After reading a book to a baby or toddler prior to bedtime, the baby often at this point is inclined to grab the book that the parent was reading and want to bring it with her or him. Children often seek out books on their own to play with. Standard books that are made out of paper and cardboard are not safe to give to a baby or toddler, or at least the books may become readily damaged by the child chewing on them. As babies are teething, they will often place any handy object in their mouths. Paper books may become torn, or may cause a choking hazard.

There are many products on the market that are designed to encourage a love for books in young children and there are many separate items used for pacifying children by allowing them to chew or suck on the object. Given the importance of early childhood development to society and individual children alike, though, the development of new ideas and products in this area is to be encouraged. In particular, a need exists for such products that are safer for infants and toddlers than conventional books, and that are not likely to present a choking hazard.

Published Patent Application 20050245968 describes a teething toy for infants and small children that is styled as an illustrated book. The toy includes a number of page-like leaves, which in the preferred embodiment are fabricated from a cloth-like material, and a number of attached teething elements. The teething elements are preferably made from a relatively hard resilient material that is textured to provide effective teething relief. In one embodiment, the teething elements are integrated into artwork that is printed on the attached page leaf. The teething toy combines effective teething relief for an infant or small child with subtle encouragement to the child that books are worthwhile objects of attention.

Alternative and improved products are still desired in this market.

### SUMMARY OF THE INVENTION

The present invention relates to a replaceable article that can be inserted and removed from the binding or backing of a children's book and which can be chewed on without damage to the book or injury to the child. The device can adhere to and slide onto the binder and extend away from the book to provide an attracting appearance. The article may be replaced or partially replaced and the size of the device avoids any significant issue of potential choking for the child.

The device may be described as for connection to a book binding of a children's book, the device and having:

a tear-resistant chewable body; and

a connector attached to the chewable body;

the connector securing the chewable body to the book binder.

### BRIEF DESCRIPTION OF THE FIGURES

FIG. 1 shows an article according to practices of the invention that may be inserted into the binding of a children's book and subsequently removed without damage to the book. A book binder is also shown in position to accept the article of the invention.

### DETAILED DESCRIPTION OF THE INVENTION

Books of any significant quality are usually constructed with pages, two rigid faces enclosing the pages to protect the pages, and a binding or back that secures the pages between the faces. Children that are teething or orally active are most likely to attempt to chew the most prominent pieces on the books, which will usually be the corners and edges of the book. A device is provided according to the present teachings that can be inserted onto a book, provide a more prominent and easily acceptable appearance and position than the pages and face and back, and be chewable by a child without harm to the child or damage to the book.

The device comprises a chewable body, preferably in the image of a character, animal or shape and an insert connector on the body that can be inserted into the receptor that adheres or securedly fits onto the binding of a book to temporarily secure the chewable body to the outside of the binding in a position that extends away from the book and is accessible by a child for teething or chewing. The term chewable excludes materials that has nutritional content and is to be eaten, such as taffy, gum, licorice and the like, as the chewable body is not intended to be swallowed or ingested, even though some incidental ingestion may occur. The chewable body is intended to be resistant to maceration and swallowing. The device can be designed with specific images and shapes and characters on the extending portion, and it will be referred to often herein as a “bookworm,” as one convenient shape for the attractive chewable end of the device is as a worm, with a face molded or printed thereon.

The device should be made of a tough, tear-resistant rubbery or elastomeric material, and should also be free of phthalates, which have potentially significant health issues, especially when ingested. Materials such as polyurethanes, acrylic elastomers, silicone elastomers, natural rubbers (which are hardened to make them more tear-resistant) and other synthetic materials may be used. The colors and imagery (e.g., eyes, mouth, nose, hair, even limbs, and the like) are preferably molded into the device, although certain paints may be used if they are chemically safe. Chewing on painted surfaces will eventually remove the paint, and that is undesirable. Molding image content into the body of the device is a well understood process and by using a single mold shape (e.g., tube-like, elongated oval, cylinder with rounded end(s), and the like, a few mold shapes may be used with many different characters by injecting the image content into the mold, with part of the elastomer being transparent or translucent to allow the image shape and colors to be viewed through the surface of the shape. The attaching element (the portion of the device that connects with the binder in the book) can be attached during the molding process or after the molding process by conventional molding techniques. A pocket may also be molded into the body and the attaching element snapped or fitted securely (or adhered) into the pocket.

If the bookshelves of most infants and toddlers are checked, the children's books will be found to have holes in the bindings of their board books, the result of chewing and gumming the bindings as a favorite pastime in the infants' first two years. Bookworm™ protectors is an accessory product for the infant/toddler market designed to protect the binders of board books yet still enable infants to satisfy their desire to chew during this phase of their development and even enhance their enjoyment of the books. The product's benefits are three-fold:
1) protects the child from ingesting undesirable and unsanitary elements, including ink, from the book cover;
2) protects and preserves the integrity of the board book; and
3) functions as a safe teether and a distraction from less desirable teething options, including the book's binder.
   Bookworm will be made in a phthalate-free plastic. Viewing the Figures attached hereto will assist in a better understanding of the practice of the present technology.

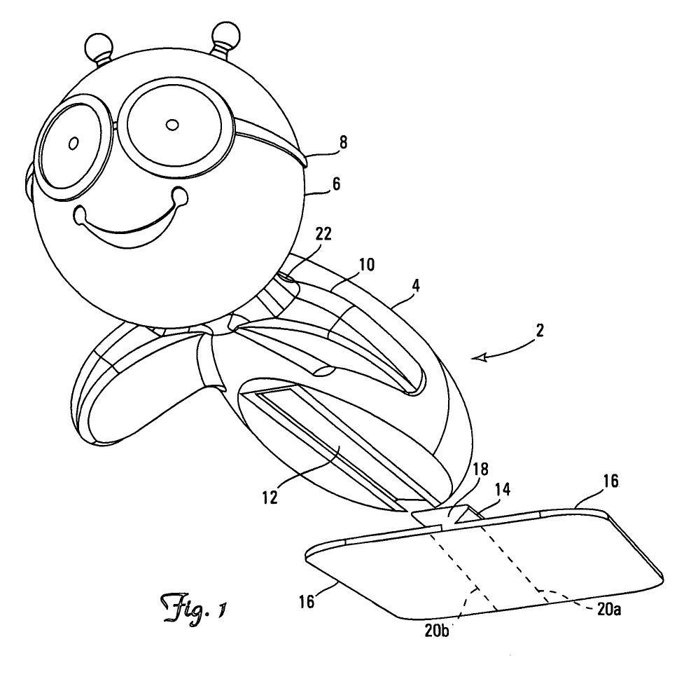

Referring now to the drawings, wherein like reference numerals designate corresponding structure throughout the views, and referring in particular to FIG. 1, a teething device 2 according to a preferred embodiment of the invention includes a molded or shaped body 4, a head 6 molded features 8 on the head 6, molded limbs 10 and a slide, glide or groove 12 to connect with a book binding 14. A benefit of the molded features, such as 8 is that the features can be pigmented (and need not be painted) and the feature is an integral part of the head 6 and will not be readily removed by chewing. The arms 10 are shown here, but may be optional or less prominent. The head may also be less prominent and merely be a colored portion of a uniform cylinder with ends containing the image of the face, tail, arms, legs, etc.

The groove 12 shown in FIG. 1 is essentially a female fitting for accepting the male insertion of the binding 14 into the groove 12. The connection may be alternatively provided by having the hole 18 in the binding receive a male element (e.g., like a flattened pen holder clip [not shown], or slide as provided on garage door openers to fit over the adjustable light shields, flaps or blinders provided in cars. The male connectors on the device (hereinafter referred to as an insert clip) may be molded into the body 4 of the device 2 or may be snapped into the existing groove 12 or similar pocket in the body 4. The insert clip or groove 12 may be a more rigid plastic, metal, composite or the like. If there is a neck portion 22 on the device 2, the neck portion 22 should be relatively thick or the head 6 nearly directly attached to the body 4 so that the head is not easily removed. A large head is relatively desirable to provide dimensions for the area of the device that is likely to be chewed to provide elements of a size that could not cause choking, even if placed in the mouth. It is also possible to have any extensions on the device (head, limbs, ears, etc.) be highly porous so that even if lodged in the mouth or throat of a child, air can pass through the extensions.

As a device is chewed up or approaches a point of damage where pieces my begin to fall off or could fall off, the device can be replaced on a book with a new device, and the book remains undamaged. As shown in FIG. 1, the faces 16 of the book are divided by the binding 14 and the (device 2 of the invention can be readily slid into or receive the natural opening 18) the male connector adheres to the binder of the book with a non-toxic adhesive of the binder 14. The book will be folded along its natural fold lines 20a and 20b and the device will not interfere with the reading of the book.

The bodies of the devices are soft and compressible for the safety, comfort and enjoyment of the infant or small child. In one embodiment, the device may have a foam core (e.g., fabricated from a polyester foam filling) with a tear-resistant coating, such as an elastomer. The head may be securable to the body (e.g., by a male-female screw and threaded receptor connector, snap fittings, adhesive, or the like) rather than being molded as a single unit. In this manner, when the head wears out, only the head need be replaced on the device.

The device and method aspects of the technology described herein may be generally described as follows. A device is provided for connection to a book binding of a children's book. The device has: a tear-resistant chewable body; and a connector attached to the chewable body; the connector having a groove therein acting as a female receptor; and a male connector that attaches directly to the binder of the book with a non-toxic adhesive. The tear-resistant chewable body may be comprised of a natural or synthetic polymer. The polymer should be free of phthalates. The connector may have a groove therein to receive a children's book binding as a female receptor and the body may have an image or shape of an animal or character molded therein. (The surface of the device should be entirely free of paint, or optionally have a non-toxic, lead-free paint. At least 15 percent by length of the device may extend above the female receptor or insert clip, so that when attached to a book binding, the at least 15% extends beyond limits of height of the book.

A method is described for protecting a children's book against damage from chewing. This may be done by providing a children's book having a binding. Two piece installation may also be used, as by adhering the rubber with attached male connector to the binding of a book with non-toxic adhesive and sliding the tear-resistant chewable device with female receptor onto the male connector. Securing a tear-resistant chewable device to the book binding so that a portion of the tear-resistant chewable device extends away from the book to facilitate chewing. The portion of the tear-resistant chewable device that extends away from the book should extend lengthwise beyond at least one end of the binding. The at least 15% of the tear-resistant chewable device should extend beyond limits of height of the book. The method may have a set of steps where the device comprises a body having a groove therein to receive a children's book binding as a female receptor. The body has an image or shape of an animal or character molded therein. The device may also be applied as a two-piece device and two-step installation, with the chewable end attached after a first part is secured to the binding. Securing the device to the binding is more secure than merely attaching the chewable device to a face or page, as those attachments would tend to be less secure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed:

1. A device for connection to a book binding of a children's book, the device comprising:
a tear-resistant chewable body; and
a connector attached to the chewable body;
the connector securing the chewable body to the book binder.

2. The device of claim 1 wherein the tear-resistant chewable body comprises a natural or synthetic polymer.

3. The device of claim 2 wherein the polymer is free of phthalates.

4. The device of claim 1 wherein the connector has a groove therein to receive a children's book binding as a receptor and the body has an image or shape of an animal or character molded therein.

5. The device of claim 4 wherein the body has a surface that is entirely free of lead paint.

6. The device of claim 1 wherein the connector has an insert clip therein to slide into an opening in a children's book binding as a male connector and the body has an image or shape of an animal or character therein.

7. The device of claim 4 wherein at least 15 percent by length of the device extends above the receptor or insert clip, so that when attached to a book binding, the at least 15% extends beyond limits of height of the book.

8. A method of protecting a children's book against damage from chewing comprising:
providing a children's book having a binding;
securing a tear-resistant chewable device to the book binding so that a portion of the tear-resistant chewable device extends away from the book to facilitate chewing.

9. The method of claim 8 wherein the portion of the tear-resistant chewable device that extends away from the book extends lengthwise beyond at least one end of the binding.

10. The method of claim 9 wherein at least 15% of the tear-resistant chewable device extends beyond limits of height of the book.

11. The method of claim 8 wherein the device attaches to an opening in the book binding.

12. The method of claim 8 wherein the device comprises a body having a groove therein to receive a children's book binding as a receptor, the body has an image or shape of an animal or character molded therein, and the binding is slid into the groove.

13. The method of claim 8 wherein the device comprises an insert clip therein, the body has an image or shape of an animal or character molded therein, and the insert clip is slid into a hole in a children's book binding as a connector.

14. A device for connection to a book binding of a children's book, the device comprising:
a tear-resistant chewable body; and
a connector attached to the chewable body;
the connector having a groove therein to receive as a receptor a structural element that secures to the book binder
